(19) United States
(12) Patent Application Publication
(10) Pub. No.: US 2015/0043312 A1
(43) Pub. Date: Feb. 12, 2015

(54) SOUND PLAYING METHOD AND DEVICE THEREOF

(71) Applicant: Tencent Technology (Shenzhen) Company Limited, Shenzhen (CN)

(72) Inventors: Xiayu WU, Shenzhen (CN); Lian GAO, Shenzhen (CN); Xuejian JIANG, Shenzhen (CN)

(73) Assignee: TENCENT TECHNOLOGY (SHENZHEN) COMPANY LIMITED, Shenzhen (CN)

(21) Appl. No.: 14/463,107

(22) Filed: Aug. 19, 2014

Related U.S. Application Data
(63) Continuation of application No. PCT/CN2014/079226, filed on Jun. 5, 2014.

(30) Foreign Application Priority Data
Aug. 8, 2013 (CN) 201310343767X

(51) Int. Cl. G08C 23/02; G06F 17/30

(52) U.S. Cl. CPC G08C 23/02; G06F 17/3074
USPC 367/197

(57) ABSTRACT

This sound playing method relates to information processing field. After receiving a sound trigger command, the sound playing device determines the sound collection event corresponding to the sound trigger command. If all audio files included in the sound collection event are loaded in the memory of the sound playing device, the sound playing device directly plays the audio file corresponding to the sound collection event. The sound playing device does not load the audio file to the memory repeatedly, so as to reuse the audio files loaded in the memory, which reduces the memory usage and improves running efficiency of the applications or art animation effects.

### CROSS-REFERENCE TO RELATED APPLICATIONS

This application is a continuation of International Application No. PCT/CN2014/079226, filed on Jun. 5, 2014, which claims priority to Chinese Patent Application No. 201310343767.X, filed on Aug. 8, 2013, which is hereby incorporated by reference in its entirety.

### FIELD

The present disclosure relates to information processing field, and more particularly to a sound playing method and a device thereof

### BACKGROUND

Currently, when an application or an animation effect is running, a single audio file or several audio files will be loaded to the corresponding running memory of the applications to trigger and play the sound. Thus, when the same audio file is triggered by several programs at the same time, the audio file will be loaded to the several running memories repeatedly, which consumes a large portion of the running memory, thereby reducing the program running efficiency of the applications.

### SUMMARY

Objectives of the present disclosure are to provide a sound playing method and a device thereof, thereby reducing the required memory storage.

In a first aspect, a sound playing method of the present disclosure includes: receiving a sound trigger command and then determining a sound collection event corresponding to the sound trigger command; and playing an audio file corresponding to the sound collection event, if all audio files included in the sound collection event having been loaded in a memory. The sound collection event comprises at least one audio file that is shared by different sound collection events.

In a second aspect, a sound playing device of the present disclosure includes: a hardware processor and a non-transitory storage medium accessible to the hardware processor. The non-transitory storage medium is configured to store an event trigger unit and a playing unit. The event trigger unit is programmed to receive a sound trigger command and then determining a sound collection event corresponding to the sound trigger command. The playing unit is programmed to play an audio file corresponding to the sound collection event, if all audio files included in the sound collection event having been loaded in a memory. The sound collection event comprises at least one audio file that is shared by different sound collection events.

Accordingly, in the sound playing method of the present disclosure, after the sound trigger command is received by the sound playing device, the sound collection event corresponding to the sound trigger command will be determined If all audio files included in the sound collection event are loaded in the memory of the sound playing device, then the audio file corresponding to the sound collection event will be played directly, but not loaded in the memory again to take up the memory, so as to reuse the audio files loaded in the memory, which reduces the memory token up and improves running efficiency of the applications or art dynamic frames therefore.

### BRIEF DESCRIPTION OF THE DRAWINGS

To explain the technical solutions of the embodiments of the present disclosure, accompanying drawings used in the embodiments are followed. Apparently, the following drawings merely illustrate some embodiments of the disclosure, but for persons skilled in the art, other drawings can be obtained without creative works according to these drawings.

FIG. 1 is a flowchart of a sound playing method according to embodiments of the present disclosure;

FIG. 2 is a flowchart of a sound playing method according to embodiments of the present disclosure;

FIG. 3 is a flowchart of a sound playing method according to embodiments of the present disclosure;

FIG. 4 is a block diagram of a sound playing device according to embodiments of the present disclosure;

FIG. 5 is a block diagram of a sound playing device according to embodiments of the present disclosure; and

FIG. 6 is a schematic view of an example embodiment of a terminal according to embodiments of the present disclosure.

### DETAILED DESCRIPTION OF THE DRAWINGS

Reference throughout this specification to “one embodiment,” “an embodiment,” “example embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an example embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof

As used herein, the term “module” or “unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module or unit may include memory (shared, dedicated, or group) that stores code executed by the processor.

The exemplary environment may include a server, a client, and a communication network. The server and the client may be coupled through the communication network for information exchange, such as sending/receiving identification information, sending/receiving data files such as splash screen images, etc. Although only one client and one server are shown in the environment, any number of terminals or servers may be included, and other devices may also be included.

The communication network may include any appropriate type of communication network for providing network connections to the server and client or among multiple servers or clients. For example, communication network may include the Internet or other types of computer networks or telecommunication networks, either wired or wireless. In a certain embodiment, the disclosed methods and apparatus may be implemented, for example, in a wireless network that includes at least one client.

In some cases, the client may refer to any appropriate user terminal with certain computing capabilities, such as a personal computer (PC), a work station computer, a server computer, a hand-held computing device (tablet), a smart phone or mobile phone, or any other user-side computing device. In various embodiments, the client may include a network access device. The client may be stationary or mobile.

A server, as used herein, may refer to one or more server computers programmed to provide certain server functionalities, such as database management and search engines. A server may also include one or more processors to execute computer programs in parallel.

The solutions in the embodiments of the present disclosure are clearly and completely described in combination with the attached drawings in the embodiments of the present disclosure. Obviously, the described embodiments are only a part, but not all, of the embodiments of the present disclosure. On the basis of the embodiments of the present disclosure, all other embodiments acquired by those of ordinary skill in the art under the precondition that no creative efforts have been made shall be covered by the protective scope of the present disclosure.

Other aspects, features, and advantages of this disclosure will become apparent from the following detailed description when taken in conjunction with the accompanying drawings. Apparently, the embodiments described thereinafter merely a part of embodiments of the present disclosure, but not all embodiments. Persons skilled in the art can obtain all other embodiments without creative works, based on these embodiments, which pertains to the protection scope of the present disclosure.

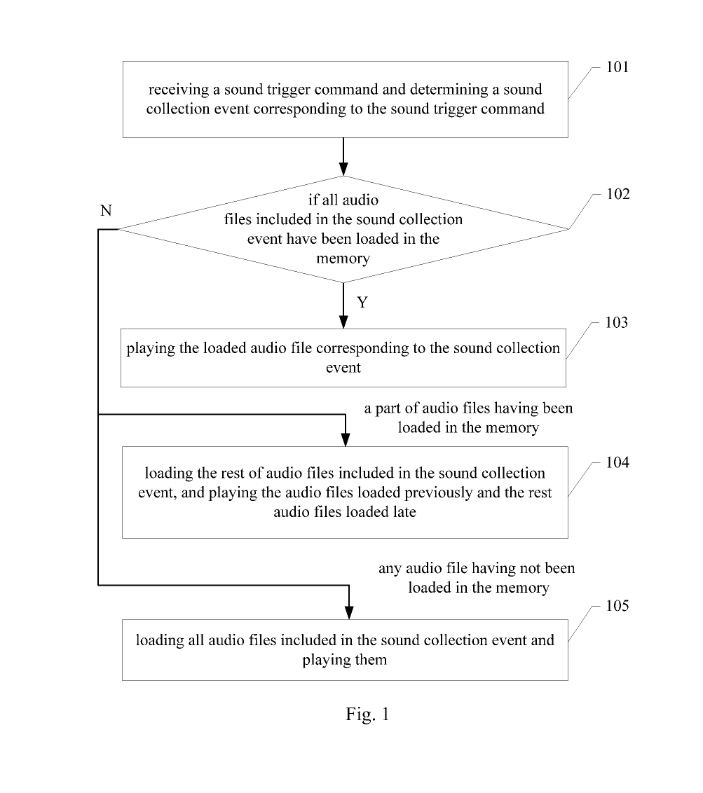

The embodiment provides a sound playing method, which is applied to trigger and play a sound during a running process of a certain application or art an animation effect. This embodiment shows a method performed by a sound playing device, including the following steps, as illustrated in FIG. 1.

Step 101, the device receives a sound trigger command and then determining a sound collection event corresponding to the sound trigger command. The sound collection event may relate to an animation effect in a video game. The sound collection event may include at least one audio file that is shared by different sound collection events. In other words, the audio files may be shared and reused with different parameters to accompany different game effects. The game effects may include animation effects, game scene changes, background music, or other effects in video games.

It should be understood that, when the sound playing device is performing a certain application or playing the animation effect, user can operate the sound playing device, so that the sound playing device triggers to carry out the sound collection event. As a result, the sound playing device will receive the sound trigger command, so as to determine which sound collection events are to be executed. Specifically, the sound collection events can be preset in the sound playing device by operators or users.

Step 102, the device determines if all audio files included in the sound collection event have been loaded in the memory of the sound playing device, if yes, reusing the audio file having been loaded in the memory and performing the step 103. As a result, no audio file is loaded again, which reduce the memory.

When executing the sound collection event, firstly, all audio files included in the sound collection event should be loaded. However, these audio files may be stored in the memory after loaded for the first time, which is convenient to play them for the next time.

Step 103, the device plays the loaded audio file corresponding to the sound collection event.

It should be noticed that, in the step 102, if not all audio files included in the sound collection event are loaded, then perform step 104 or 105 as following.

Step 104, if a part of audio files included in the sound collection event having been loaded in the memory, then continuing to load the rest of audio files included in the sound collection event, and playing the audio files loaded previously and the rest of audio files loaded late.

Step 105, if any audio file included in the sound collection event having not been loaded in the memory, the device loads all audio files included in the sound collection event and plays them.

By this token, in the sound playing method of the present disclosure, after the sound trigger command is received by the sound playing device, the sound collection event corresponding to the sound trigger command will be determined If all audio files included in the sound collection event are loaded in the memory of the sound playing device, then the audio file corresponding to the sound collection event will be played directly, but not loaded in the memory again to take up the memory, so as to reuse the audio files loaded in the memory, which reduces the memory token up and improves running efficiency of the applications or an animation effect therefore.

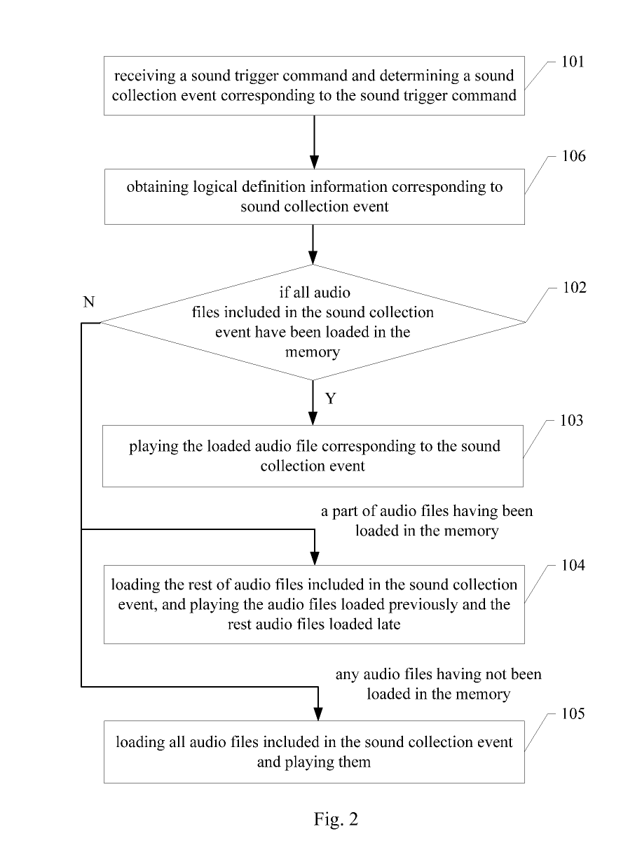

As shown in FIG. 2, as an example embodiment, it further includes restricting the implement to the sound collection event, to improve the playing effect of the audio files in the sound collection event. For example, step 106 of obtaining logical definition information corresponding to sound collection event is performed after the step 101. In this condition, the audio file will be played according to the logical definition information when the sound playing device is performing step of playing the audio file in the steps 103 to 105.

Specifically, the logical definition information comprises at least one of: volume, maximum playing samples, loading mode of audio files, loading node, randomly playing rate, playlist executive mode, and playing invalid mapping, etc., which is not limited.

For example, the volume means the magnitude of playing output volume of the sound collection event. The maximum playing samples means the maximum value of the amount of the audio file samples playing at the same time in the sound collection event. The loading mode of audio files includes that, the audio files can be unzipped to play while loading, or the audio files are unzipped to the memory to wait for playing, or the zipped files are copied to the memory to wait for unzipping to play. The loading node means the position for executing the sound collection event. The randomly playing rate means the rate of playing the audio files included in the sound collection event randomly. The playlist executive mode means the playing mode of the audio files included in the sound collection event, such as disordered random, sequential play or random play without repeating. And the playing invalid mapping means the information of the audio files which are unable to play.

It should be noticed that, the order for performing the step 106 and 102 is not limited, they can be performed synchronously or in order, FIG. 2 just illustrates a specific performing mode.

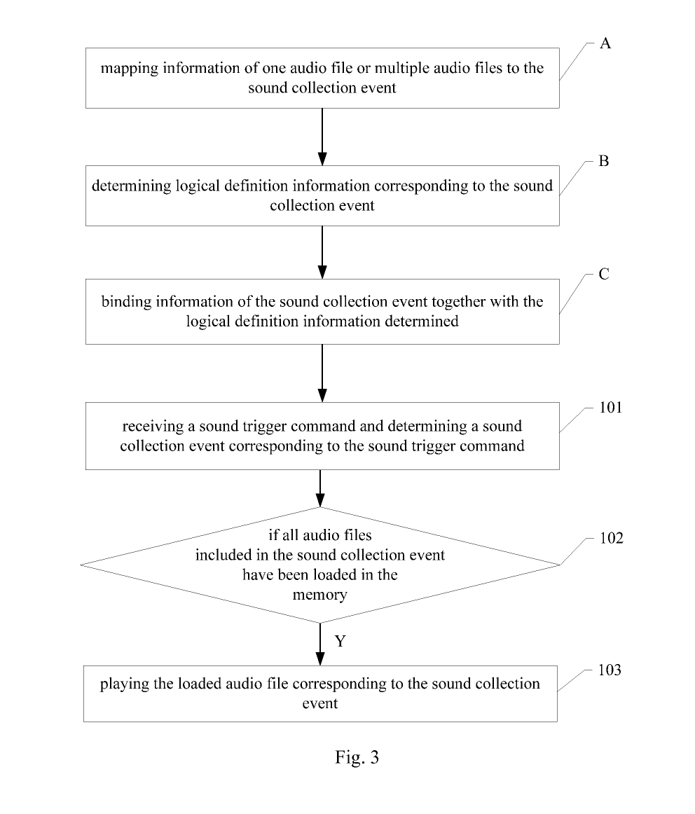

As shown in FIG. 3, information related to the sound collection event such as audio files and logical determination information can be present in the sound playing device by the operators. For example, before the step 101 is performed, the following steps are performed.

Step A, mapping information of one audio file or multiple audio files to the sound collection event, namely, associating one audio file or multiple audio files with the sound collection event, therein one audio file can be mapped repeatedly to the different sound collection events. Thus, the sound collection event includes at least one audio file that is shared by different sound collection events.

Step B, determining logical definition information corresponding to the sound collection event.

Step C, binding information of the sound collection event together with the logical definition information determined in the step B, namely, the information of the sound collection event is stored correspondingly to the logical determination information. For example, the information of the sound collection event includes information of all audio files included in the sound collection event, such as identification information of the audio files.

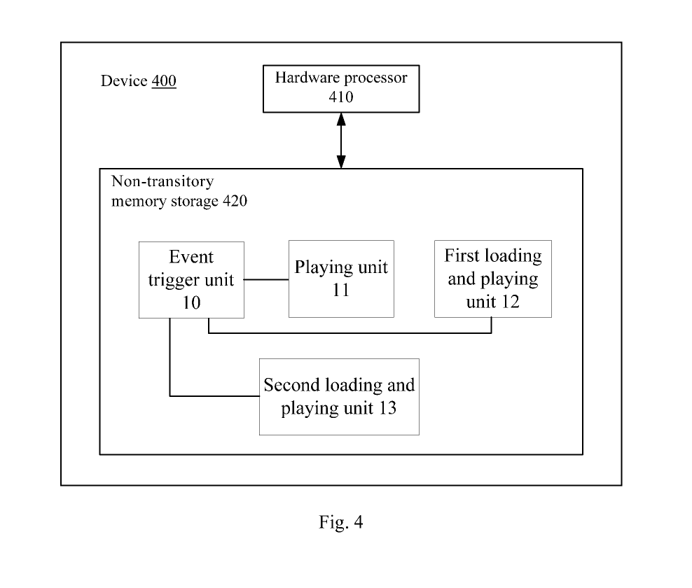

Accordingly, the embodiment of the present disclosure provides a sound playing device 400 illustrated in FIG. 4. The device 400 includes: a hardware processor 410 and a non-transitory storage medium 420 accessible to the hardware processor. The non-transitory storage medium 420 is configured to store an event trigger unit 10 and a playing unit 11.

The event trigger unit 10 is programmed to receive a sound trigger command and then determining a sound collection event corresponding to the sound trigger command The playing unit 11 is programmed to playing an audio file corresponding to the sound collection event, if all audio files included in the sound collection event having been loaded in a memory.

The sound playing device further includes a first loading and playing unit 12 and a second loading and playing unit 13. Here, the first loading and playing unit 12 is programmed to, if a part of audio files included in the sound collection event having been loaded in the memory, then continuing to load the rest of audio files included in the sound collection event, and playing the audio files loaded previously and the rest of audio files loaded later. The second loading and playing unit 13 is programmed to, if any audio file included in the sound collection event having not been loaded in the memory, then loading all audio files included in the sound collection event and playing them.

In the embodiment of the sound playing device, when the sound trigger command is received by the event trigger unit 10, the sound collection event corresponding to the sound trigger command will be determined If all audio files included in the sound collection event are loaded in the memory of the sound playing device, then the audio file corresponding to the sound collection event will be played directly by the playing unit 11, but not loaded in the memory again to take up the memory, so as to reuse the audio files loaded in the memory, which reduces the memory token up and improves running efficiency of the applications or the animation effect therefore.

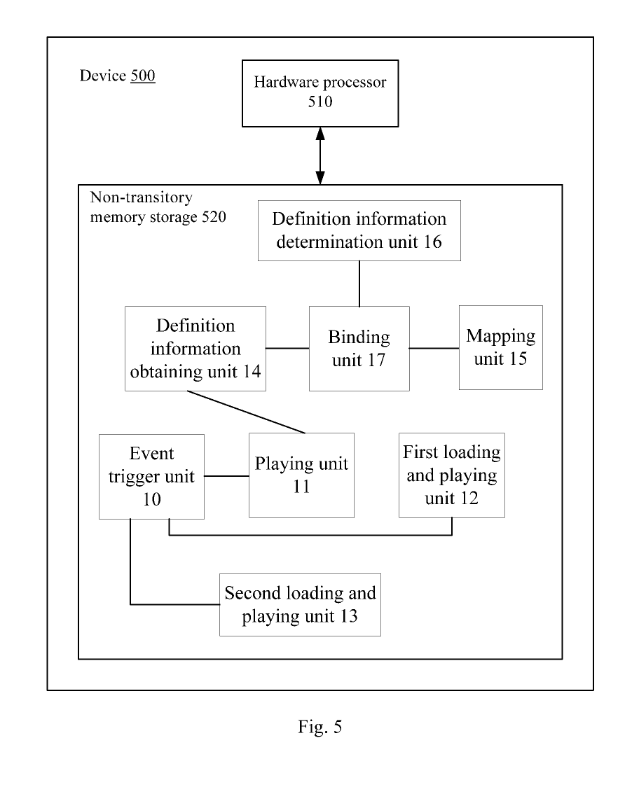

Referring to FIG. 5, in an example embodiment, the sound playing device 500 has similar structure as the sound playing device 400 in FIG. 4. Here, the sound playing device 500 further includes a definition information obtaining unit 14, a mapping unit 15, a definition information determination unit 16, and a binding unit 17.

For example, the definition information obtaining unit 14 is programmed to obtaining logical definition information corresponding to the sound collection event.

The mapping unit 15 is programmed to mapping information of one audio file or multiple audio files to the sound collection event.

The definition information determination unit 16 is programmed to determining logical definition information corresponding to the sound collection event. Specifically, the logical definition information comprises at least one of: volume, maximum playing samples, loading mode of audio files, loading node, randomly playing rate, playlist executive mode, and playing invalid mapping, etc.

The binding unit 17 is programmed to bind information of the sound collection event mapped by the mapping unit 15 together with the logical definition information determined by the definition information determination unit 16, and the information of the sound collection event includes information of all audio files included in the sound collection event.

In this embodiment, after the sound collection event to be performed is determined by the event trigger unit 10, the logical definition information of the sound collection event will be obtained by the definition information obtaining unit 14. While playing, the playing unit 11, the first and second loading and playing units 12, 13 play the audio files in the sound collection event according to the logical definition information obtained by the definition information obtaining unit 14. Furthermore, in the embodiment, the information related to the sound collection event can be preset by the mapping unit 15, the definition information determination unit 16 and the binding unit 17. In this condition, the logical definition information can be obtained by the definition information obtaining unit 14 according to the information stored in the binding unit 17.

Following is an example that the sound playing method may be implemented by a terminal that includes smart phones, tablet PCs, e-book readers, Moving Picture Experts Group Audio Layer III (MP3) players, Moving Picture Experts Group Audio Layer IV (MP4) players, portable laptop computers and desktop computers, etc.

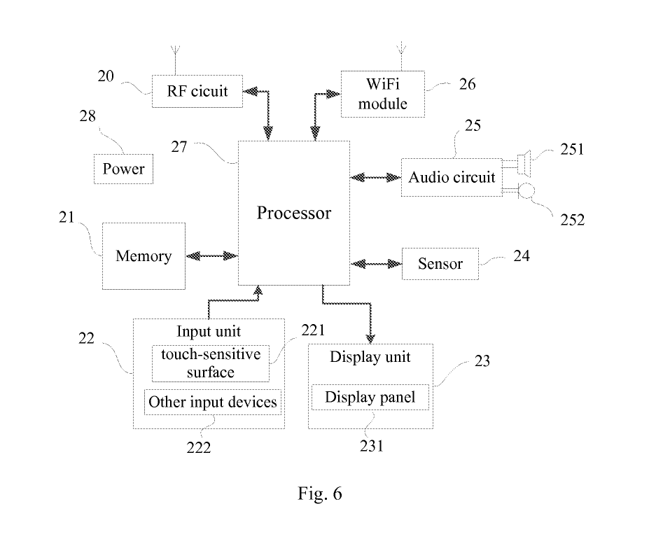

FIG. 6 shows a block diagram of an example embodiment of the terminal

For example, the terminal includes a radio frequency (RF) circuit 20, a memory 21 including one or more computer-readable storage mediums, an input unit 22, a display unit 23, a sensor 24, an audio circuit 25, a wireless fidelity (WiFi) module 26, a processor 27 including one or more cores, and a power 28, etc. It's understood that, the structure of the terminal shown in FIG. 6 is not limiting, it can includes less or more components, or includes other combinations or arrangements.

Specifically, the RF circuit 20 can be used for receiving and sending signals during calling or process of receiving and sending message. Specially, the RF circuit 20 will receive downlink information from the base station and send it to the processor 27; or send uplink data to the base station. Generally, the RF circuit 20 includes, but is not limited to, an antenna, at least one amplifier, a transceiver, a coupler, a low noise amplifier (LNA), a diplexer, and the like. In addition, the RF circuit 20 can communicate with network or other devices by wireless communication. Such wireless communication can use any communication standard or protocol, which includes, but is not limited to, Global System of Mobile communication (GSM), (General Packet Radio Service, GPRS), (Code Division Multiple Access, CDMA), (Wideband Code Division Multiple Access, WCDMA), (Long Term Evolution, LTE), email, or (Short Messaging Service, SMS).

The memory 21 is configured to store software program and module which will be run by the processor 27, so as to perform multiple functional applications of the mobile phone and data processing. The memory 21 mainly includes storing program area and storing data area. For example, the storing program area can store the operating system, at least one application program with required function (such as sound playing function, image playing function, etc.). The storing data area can store data established by mobile phone according to actual using demand (such as audio data, phonebook, etc.) Furthermore, the memory 21 can be high-speed random access memory, or nonvolatile memory, such as disk storage, flash memory device, or other volatile solid-state memory devices. Accordingly, the memory 21 may include a storing controller to help the processor 27 and the input unit 22 to access the memory 21.

The input unit 22 is programmed to receive the entered number or character information, and the entered key signal related to user setting and function control. For example, the input unit 22 includes a touch-sensitive surface 221 or other input devices 222. The touch-sensitive surface 221 is called as touch screen or touch panel, which can collect user's touch operations thereon or nearby (for example the operations generated by fingers of user or stylus pen, and the like, touching on or near the touch-sensitive surface 221), and drive the corresponding connection device according to the preset program. Optionally, the touch-sensitive surface 221 includes two portions including a touch detection device and a touch controller. Specifically, the touch detection device is programmed to detect touch position of the user and detecting signals accordingly, and then sending the signals to the touch controller. Subsequently, the touch controller receives touch information from the touch detection device, and converts it to contact coordinates which are to be sent to the processor 27, and then receives command sent by the processor 27 to perform. In addition, besides the touch-sensitive surface 221, the input unit 22 can include, but is not limited to, other input devices 222, such as one or more selected from physical keyboard, function keys (such as volume control keys, switch key-press, etc.), a trackball, a mouse, and an operating lever, etc.

The display unit 23 is programmed to display information entered by the user or information supplied to the user, and menus of the mobile phone. For example, the display unit 23 includes a display panel 231, such as a Liquid Crystal Display (LCD), or an Organic Light-Emitting Diode (OLED). Furthermore, the display panel 231 can be covered by the touch-sensitive surface 221, after touch operations are detected on or near the touch-sensitive surface 221, they will be sent to the processor 27 to determine the type of the touching event. Subsequently, the processor 27 supplies the corresponding visual output to the display panel 231 according to the type of the touching event. As shown in FIG. 6, the touch-sensitive surface 221 and the display panel 231 are two individual components to implement input and output, but they can be integrated together to implement the input and output in some embodiments.

Furthermore, the terminal may include at least one sensor 24, such as light sensors, motion sensors, or other sensors. Specifically, the light sensors includes ambient light sensors for adjusting brightness of the display panel 231 according to the ambient light, and proximity sensors for turning off the display panel 231 and/or maintaining backlight when the terminal is moved to the ear side. Accelerometer sensor as one of the motion sensors can detect the magnitude of accelerations in every direction (Triaxial, generally), and detect the magnitude and direction of gravity in an immobile status, which is applicable to applications of identifying attitudes of the mobile (such as switching between horizontal and vertical screens, related games, magnetometer attitude calibration, etc.), vibration recognition related functions (such as pedometer, percussion, etc.). And the terminal also can configure other sensors (such as gyroscopes, barometers, hygrometers, thermometers, infrared sensors, etc.) whose detailed descriptions are omitted here.

The audio circuit 25, the speaker 251 and the microphone 252 supply an audio interface between the user and the terminal Specifically, the audio data is received and converted to electrical signals by audio circuit 25, and then transmitted to the speaker 251, which are converted to sound signal to output. On the other hand, the sound signal collected by the speaker is then converted to electrical signals which will be received and converted to audio data. Subsequently, the audio data are output to the processor 27 to process, and then sent to another mobile phone via the RF circuit 20, or sent to the memory 21 to process further. The audio circuit 25 may further include an earplug jack to provide a communication between the external earphone and the terminal

WiFi pertains to short-range wireless transmission technology providing a wireless broadband Internet, by which the mobile phone can help the user to receive and send email, browse web, and access streaming media, etc. Although the WiFi module 26 is illustrated in FIG. 6, it should be understood that, WiFi module 26 is not a necessary for the terminal, which can be omitted according the actual demand without changing the essence of the present disclosure.

The processor 27 is a control center of the mobile phone, which connects with every part of the mobile phone by various interfaces or circuits, and performs various functions and processes data by running or performing software program/module stored in the memory 21 or calling data stored in the memory 21, so as to monitor the mobile phone. Optionally, the processor 27 may include one or more processing units. Preferably, the processor 27 can integrate with application processors and modem processors, for example, the application processors include processing operating system, user interface and applications, etc.; the modern processors are used for performing wireless communication. It can be understood that, it's an option to integrate the modern processors to the processor 27.

Furthermore, the terminal may include a power supply 28 (such as battery) supplying power for each component, preferably, the power supply can connect with the processor 27 by power management system, so as to manage charging, discharging and power consuming The power supply 28 may include one or more AC or DC powers, recharging systems, power failure detection circuits, power converters or inverters, or power status indicators, etc.

In addition, the terminal may include a camera, and a Bluetooth module, etc., which are not illustrated. In this embodiment, the processor 27 of the terminal will perform an executable file stored in the memory 21 according to one or more program of the application, as the following steps.

When a sound trigger command is received, a sound collection event corresponding to the sound trigger command then will be determined If all audio files included in the sound collection event has been loaded in the memory 21, the audio file corresponding to the sound collection event will be played, namely sent to the display unit 23 to display. If only a part of audio files included in the sound collection event has been loaded in the memory, then the rest of audio files included in the sound collection event is continued to load, and then the audio files loaded previously and the rest of audio files loaded later will be played. If any audio file included in the sound collection event has not been loaded in the memory, then all audio files included in the sound collection event will be loaded and played.

Furthermore, the processor 27 is further programmed to obtain logical definition information corresponding to the sound collection event, after determining the sound collection event corresponding to the sound trigger command. And the audio files will be played according to the logical definition information obtained. In this embodiment, the processor 27 is further programmed to preset the information associated with the sound collection event by the following commands.

Mapping information of one audio file or multiple audio files to the sound collection event, and determining logical definition information corresponding to the sound collection event. For example, the logical definition information comprises at least one of: volume, maximum playing samples, loading mode of audio files, loading node, randomly playing rate, playlist executive mode, and playing invalid mapping. Binding information of the sound collection event together with the logical definition information determined, and therein the information of the sound collection event includes information of all audio files included in the sound collection event.

It's understood for person skilled in the art to accomplish part of or whole steps in the embodiment mentioned above by instructing the related hardware with program. Such program can be stored in a computer-readable storage medium such as read-only memory (ROM), Random Access Memory (RAM), magnetic or optical disk, etc.

While the disclosure has been described in connection with what are presently considered to be the most practical and preferred embodiments, it is to be understood that the disclosure is not to be limited to the disclosed embodiments, but on the contrary, is intended to cover various modifications and equivalent arrangements included within the spirit and scope of the disclosure.

What is claimed is:

1. A method for playing sound, comprising:
receiving, by a device having a processor and a memory, a sound trigger command;
determining, by the device, a sound collection event corresponding to the sound trigger command; and
playing, by the device, an audio file corresponding to the sound collection event, if all audio files included in the sound collection event have been loaded in the memory,
wherein the sound collection event comprises at least one audio file that is shared by different sound collection events.

2. The method according to claim 1, further comprising:
if a part of audio files included in the sound collection event has been loaded in the memory, then continuing to load the rest of audio files included in the sound collection event, and playing the audio files loaded previously and the rest of audio files loaded later; and
if any audio file included in the sound collection event has not been loaded in the memory, then loading all audio files included in the sound collection event and playing all audio files.

3. The method according to claim 1, after determining the sound collection event corresponding to the sound trigger command, further comprising:
obtaining logical definition information corresponding to the sound collection event,
wherein playing the audio files comprises playing the audio files according to the logical definition information.

4. The method according to claim 3, further comprising:
mapping information of one audio file or multiple audio files to the sound collection event;
determining logical definition information corresponding to the sound collection event; and
binding information of the sound collection event together with the logical definition information determined, wherein the information of the sound collection event comprise information of all audio files included in the sound collection event.

5. The method according to claim 3, wherein the logical definition information comprises at least one of: volume, maximum playing samples, loading mode of audio files, loading node, randomly playing rate, playlist executive mode, and playing invalid mapping.

6. A sound playing device, comprising a hardware processor and a non-transitory storage medium comprising:
an event trigger unit, programmed to receive a sound trigger command and determine a sound collection event corresponding to the sound trigger command; and
a playing unit, programmed to play an audio file corresponding to the sound collection event, if all audio files included in the sound collection event having been loaded in a memory,
wherein the sound collection event comprises at least one audio file that is shared by different sound collection events.

7. The device according to claim 6, further comprising:
a first loading and playing unit, programmed to, if a part of audio files included in the sound collection event having been loaded in the memory, load the rest of audio files included in the sound collection event, and play the audio files loaded previously and the rest of audio files loaded later; and
a second loading and playing unit, programmed to, if any audio file included in the sound collection event having not been loaded in the memory, load all audio files included in the sound collection event and play all audio files.

8. The device according to claim 6, further comprising:
a definition information obtaining unit, programmed to obtain logical definition information corresponding to the sound collection event;
and the playing unit programmed to play the audio files according to the logical definition information.

9. The device according to claim 8, further comprising:
a mapping unit, programmed to map information of one or more audio files to the sound collection event;
a definition information determination unit, programmed to determine logical definition information corresponding to the sound collection event; and
a binding unit, programmed to bind information of the sound collection event together with the logical definition information determined, wherein the information of the sound collection event comprises information of all audio files included in the sound collection event.

10. The device according to claim 8, wherein the logical definition information comprises at least one of: volume, maximum playing samples, loading mode of audio files, loading node, randomly playing rate, playlist executive mode, and playing invalid mapping.

11. A sound playing device, comprising a hardware processor and a non-transitory storage medium, the sound playing device is programmed to:
receive a sound trigger command and determine a sound collection event corresponding to the sound trigger command; and
play an audio file corresponding to the sound collection event, if all audio files included in the sound collection event having been loaded in a memory,
wherein the sound collection event comprises at least one audio file that is shared by different sound collection events.

12. The device according to claim 11, further programmed to:
if a part of audio files included in the sound collection event having been loaded in the memory, load the rest of audio files included in the sound collection event, and play the audio files loaded previously and the rest of audio files loaded later; and
if any audio file included in the sound collection event having not been loaded in the memory, load all audio files included in the sound collection event and play all audio files.

13. The device according to claim 11, further programmed to:
obtain logical definition information corresponding to the sound collection event; and
play the audio files according to the logical definition information.

14. The device according to claim 13, further programmed to:
map information of one or more audio files to the sound collection event;
determine logical definition information corresponding to the sound collection event; and
bind information of the sound collection event together with the logical definition information determined, wherein the information of the sound collection event comprises information of all audio files included in the sound collection event.

15. The device according to claim 13, wherein the logical definition information comprises at least one of: volume, maximum playing samples, loading mode of audio files, loading node, randomly playing rate, playlist executive mode, and playing invalid mapping.
